(19) United States
(12) Patent Application Publication
(10) Pub. No.: US 2009/0015001 A1
(43) Pub. Date: Jan. 15, 2009

(54) COMBINATION POSTCARD AND CROSSWORD PUZZLE

(76) Inventor: Hans Arne Haldorsen, Darbu (NO)

Correspondence Address: SCHNECK & SCHNECK, P.O. BOX 2-E, SAN JOSE, CA, 95109-0005, US

(21) Appl. No.: 12/013,335

(22) Filed: Jan. 11, 2008

(30) Foreign Application Priority Data
Jul. 12, 2007 (NO) 20070439
Jul. 27, 2007 (NO) 20070471

(51) Int. Cl. A63F 9/18; B42D 15/04; G09F 13/00; G09F 1/00

(52) U.S. Cl. 283/102; 229/92.8; 273/240; 40/124.02; 40/124.03; 40/124.08; 283/100

(57) ABSTRACT

A postcard combined with a puzzle to furnish the recipient with a diversion beyond merely reading the card. Preferred embodiments of the puzzle postcard, besides having the usual space for placing postage and a recipient's address and a space adorned with a symbolic representation and/or for writing a message to the recipient, also have at least one puzzle suited to be solved on a two-dimensional board. The contemplated puzzles may be not only ordinary crossword puzzles, but also Sudoku puzzles, code puzzles (relating numbers to words), and any other word- or number-related type puzzles suited to be solved on a two-dimensional board.

### TECHNICAL FIELD

The present invention relates generally to postcards and more particularly to postcards for extended entertainment.

### BACKGROUND

Conventional postcards are intended to convey a message or sentiment to the recipient, and come in many shapes and designs. Postcards may be heart-shaped or flower-shaped (for Valentine's Day), skull-shaped (for Halloween), snowflake-shaped (for Christmas) or ordinary square-shaped. Postcards may be of a single-sheet type, double-sheet type or multiple-sheet type with one or more foldings. Postcards may also be equipped with pop-up structures and/or devices for producing sound- and/or light.

However, when a recipient receives such a conventional postcard all that he or she can do with it is to read the message and possibly look at the decoration/pictures. In many cases, however, as for example when the recipient is in a place perceived as tedious (e.g. a boarding school, the military, a hospital, jail, etc.) the recipient would like more of a diversion.

Thus there is a need for a postcard that provides an improved diversion.

### SUMMARY OF THE INVENTION

The present invention provides a postcard combined with a puzzle to furnish the recipient with a diversion beyond merely reading the card. Preferred embodiments of the puzzle postcard, besides having the usual space for placing postage and a recipient's address and a space adorned with a symbolic representation and/or for writing a message to the recipient, also have at least one puzzle suited to be solved on a two-dimensional board. The contemplated puzzles may be not only ordinary crossword puzzles, but also Sudoku puzzles, code puzzles (relating numbers to words), and any other word- or number-related type puzzles suited to be solved on a two-dimensional board.

Preferred embodiments may also on their reverse sides or behind peel-off stickers include solutions to the puzzles in case the recipients get stuck.

Such postcard-puzzles may further be arranged so that their solutions convey messages, creating an incentive for the recipient to solve the puzzle and thereby relieving tedium.

### BRIEF DESCRIPTION OF THE DRAWINGS

The following description will be better understood with reference to the accompanying figures, wherein:

FIG. 1 shows a postcard according to an embodiment of the invention bearing a cryptic crossword puzzle;

FIG. 2 shows a postcard according to an embodiment of the invention bearing an American crossword puzzle;

FIG. 3 shows a postcard according to an embodiment of the invention bearing a crisscross crossword puzzle;

FIG. 4a shows the back and front of a double card postcard according to an embodiment of the invention depicting a spring motif;

FIG. 4b shows the embodiment of FIG. 4a of the inside/middle of a double card postcard according to an embodiment of the invention bearing a cryptic crossword puzzle;

FIG. 5a shows the back and front of a double card postcard according to an embodiment of the invention depicting a winter motif. The back of the card includes a miniature version of the puzzle filled in with the solution, which is initially hidden under an opaque peel-off label, shown partially lifted;

FIG. 5b shows the embodiment of FIG. 5a of the inside/middle of a double card postcard according to an embodiment of the invention bearing an American crossword puzzle;

FIG. 6a shows the back and front of a double card postcard according to an embodiment of the invention depicting an autumn motif;

FIG. 6b shows the embodiment of FIG. 6a of the inside/middle of a double card postcard according to an embodiment of the invention bearing a crisscross crossword puzzle;

FIG. 7a shows the back and front of a double card postcard according to an embodiment of the invention depicting a spring motif;

FIG. 7b shows the embodiment of FIG. 7a of the inside/middle of a double card postcard according to an embodiment of the invention bearing a crossword puzzle;

FIG. 8a shows the front and back of a double postcard according to an embodiment of the invention depicting a winter motif;

FIG. 8b shows the embodiment of FIG. 8a of the inside/middle of a double card postcard according to an embodiment of the invention bearing a crossword with a solution phrase relating to a corner picture in the crossword puzzle;

FIG. 9a shows the front of a single sheet postcard according to an embodiment of the invention bearing a code crossword puzzle;

FIG. 9b shows the back of the postcard according to an embodiment of the invention according to FIG. 9a also including the solution to the front side puzzle in a miniaturized version;

FIG. 10a shows the front of a single sheet postcard according to an embodiment of the invention bearing a crossword puzzle relating to pictures;

FIG. 10b shows the backside of the postcard according to an embodiment of the invention according to FIG. 10a bearing the solution to the crossword puzzle in a miniaturized version;

FIG. 11a shows the front of a single sheet postcard according to an embodiment of the invention bearing a Sudoku number puzzle;

FIG. 11b shows the backside of the postcard according to an embodiment of the invention according to FIG. 11a bearing the solution to the Sudoku number puzzle in a miniaturized version;

FIG. 12a shows the front of a single sheet postcard according to an embodiment of the invention bearing an alternative Sudoku number puzzle; and

FIG. 12b shows the backside of the postcard according to an embodiment of the invention according to FIG. 12a bearing the solution to the Sudoku number puzzle in a miniaturized version.

### DETAILED DESCRIPTION

The present invention provides a postcard enhanced with a two-dimensional puzzle. In addition to the usual spaces for affixing postage and writing the recipient's address, and a symbolic representation or a space intended for writing a message to the recipient, postcards according to the invention also include at least one puzzle. In one embodiment the puzzle may be an ordinary crossword puzzle based on key words (synonyms), phrases, or pictures as hints for finding words made up of common letters in a horizontal and vertical arrangement. In other embodiments the puzzle may also, or alternatively, include Sudoku puzzles, code puzzles (relating numbers to words), and any other word- or number-related puzzles suited to be solved on a two-dimensional board.

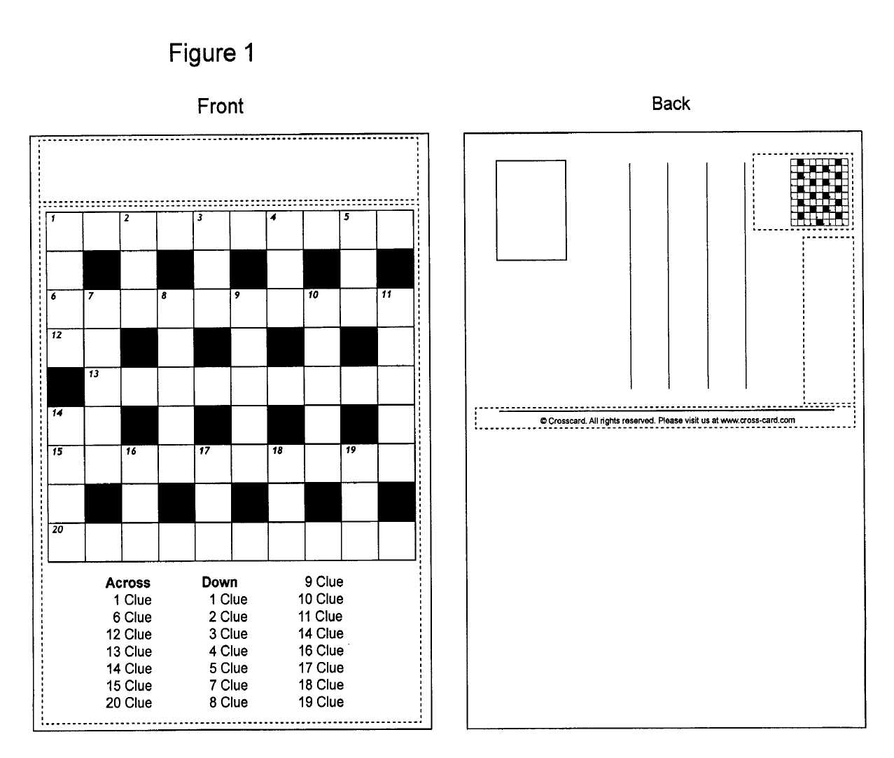

FIG. 1 shows a postcard according to an embodiment of the invention bearing a cryptic crossword puzzle.

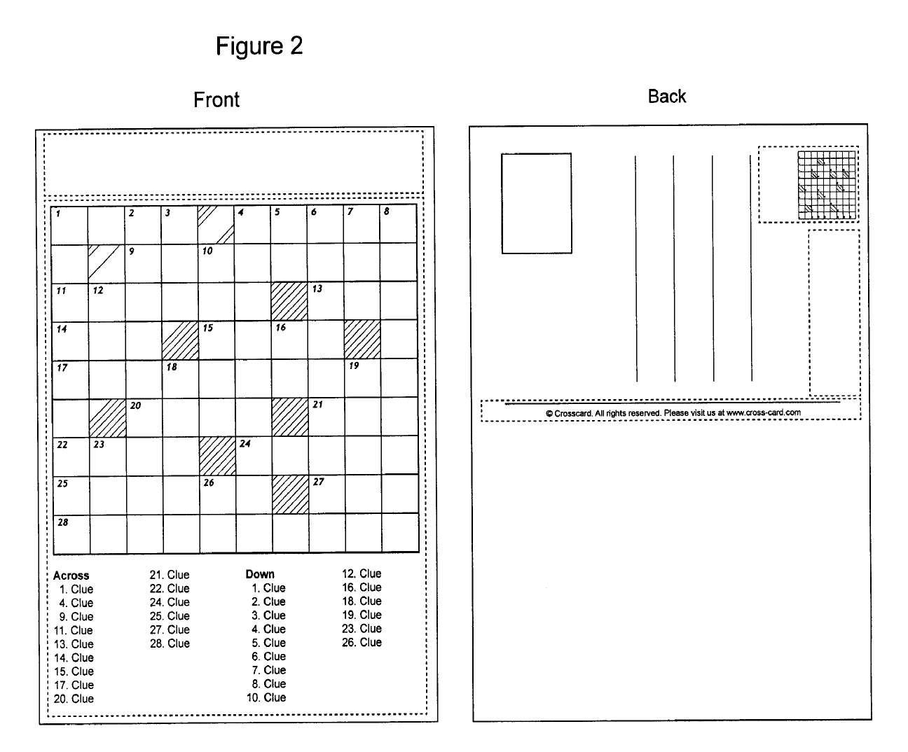

FIG. 2 shows a postcard according to an embodiment of the invention bearing an American crossword puzzle.

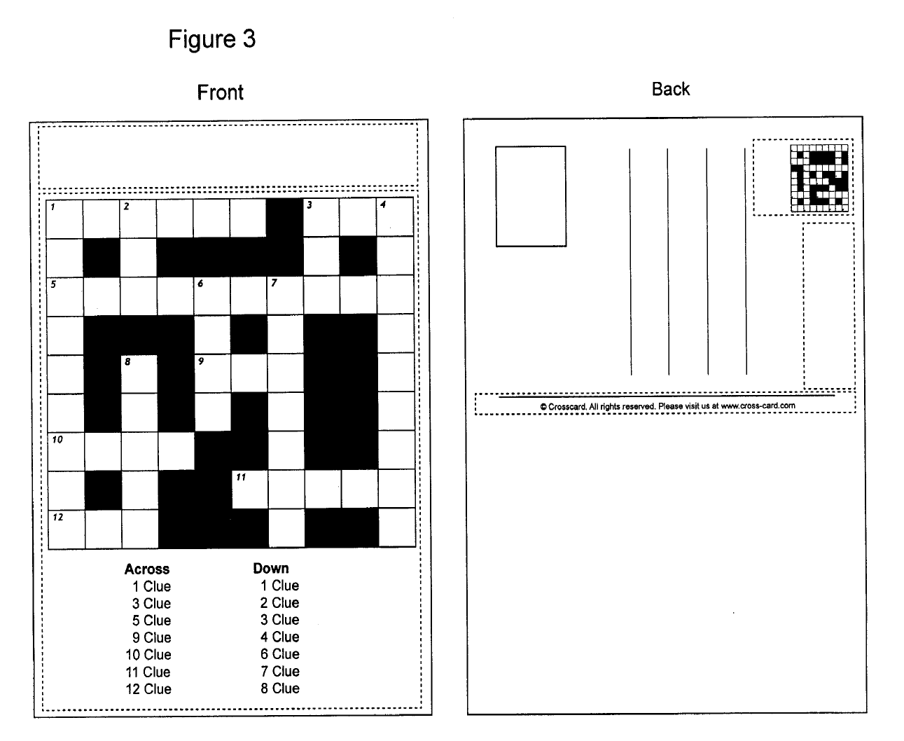

FIG. 3 shows a postcard according to an embodiment of the invention bearing a crisscross crossword puzzle.

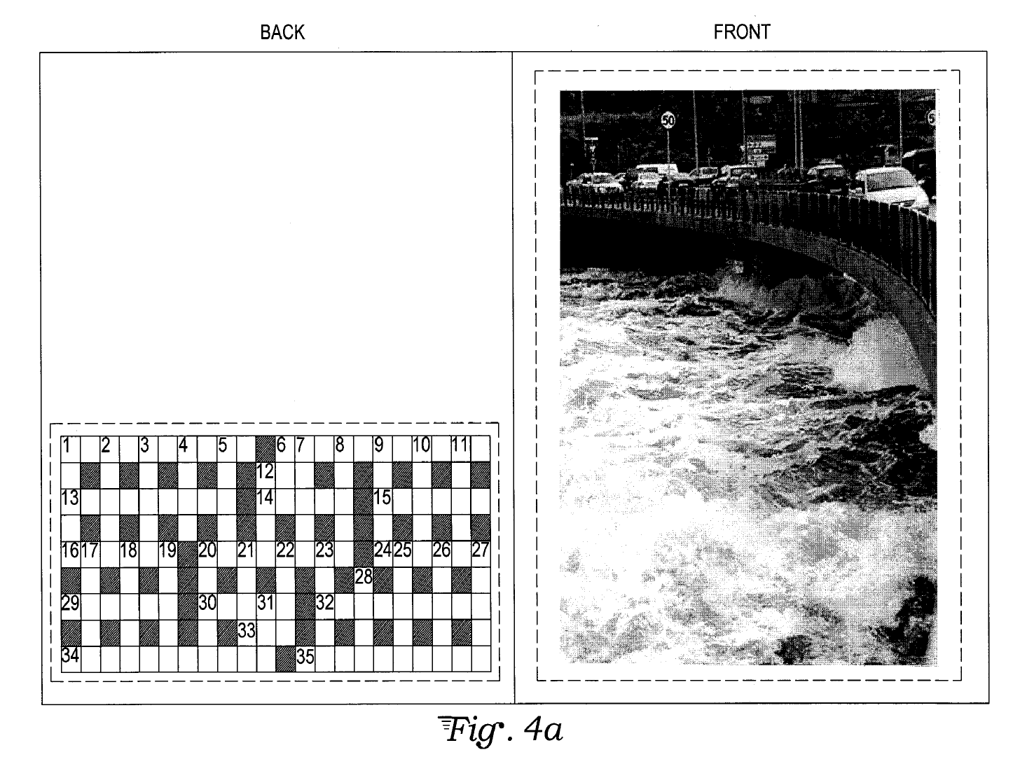

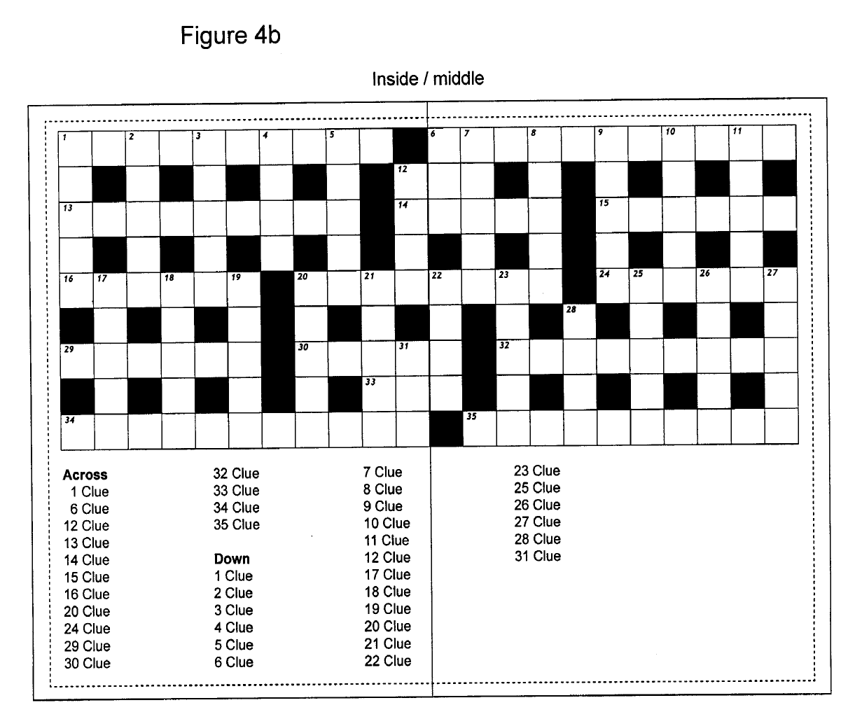

FIG. 4a shows the back and front of a double card postcard according to an embodiment of the invention including a picture depicting a spring motif. FIG. 4b shows the inside/middle of the embodiment of FIG. 4a bearing a cryptic crossword. On such a postcard, a picture, decoration, or design may provide one or more clues, such as a place name, for solving the accompanying puzzle.

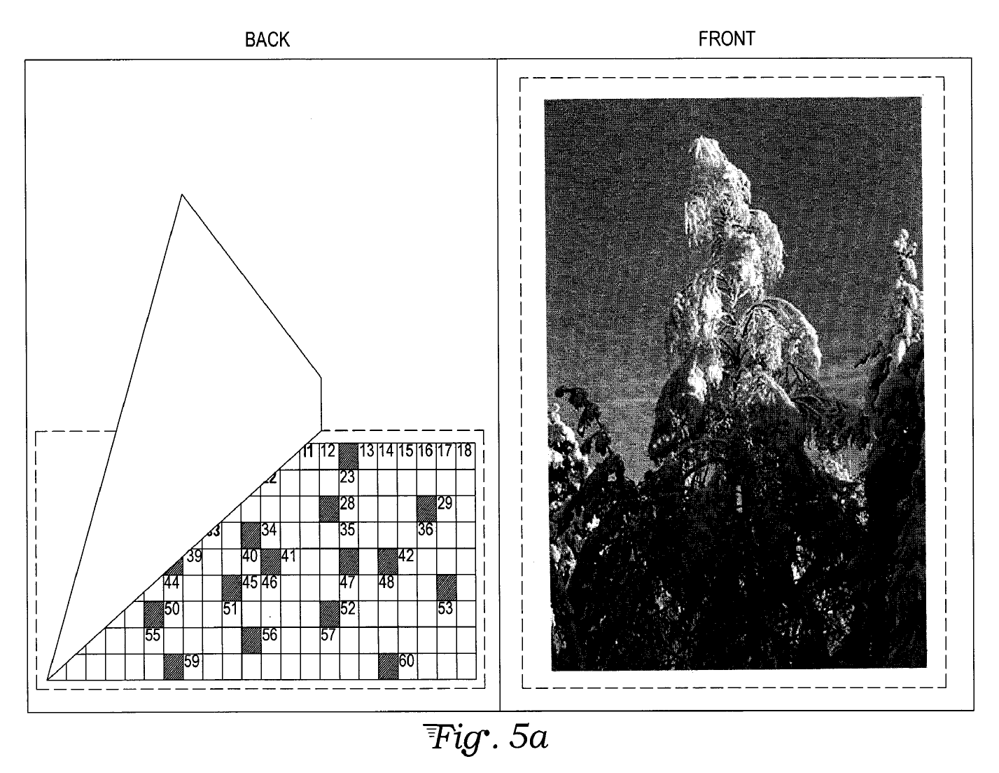

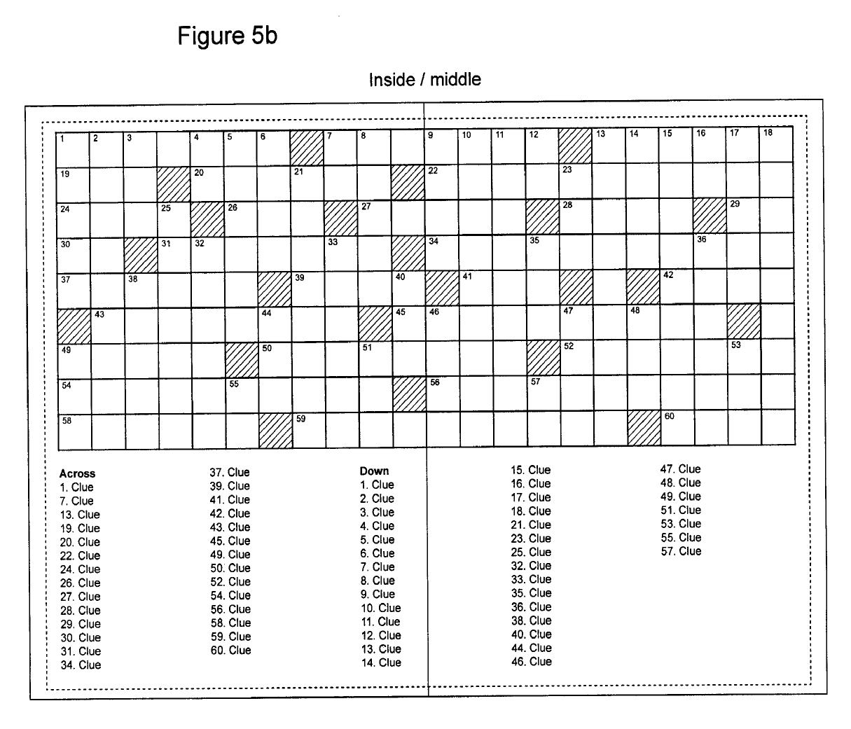

FIG. 5a shows the back and front of a double card postcard according to an embodiment of the invention depicting a winter motif. The back of the card includes a miniature version of the puzzle filled in with the solution. In this embodiment the solution is initially hidden under a cover such as an opaque peel-off label, shown partially lifted in FIG. 5a. Alternatively, the filled-in version and the peel-off label could be larger (not shown), occupying more or all of the blank area intended for writing messages, and the label could have a surface suitable for writing on. As another alternative, instead of the miniature version of the puzzle being covered with a peel-off label it could be covered with opaque scratch-off material. FIG. 5b shows the inside/middle of the embodiment of FIG. 5a of a double card postcard bearing an American crossword puzzle.

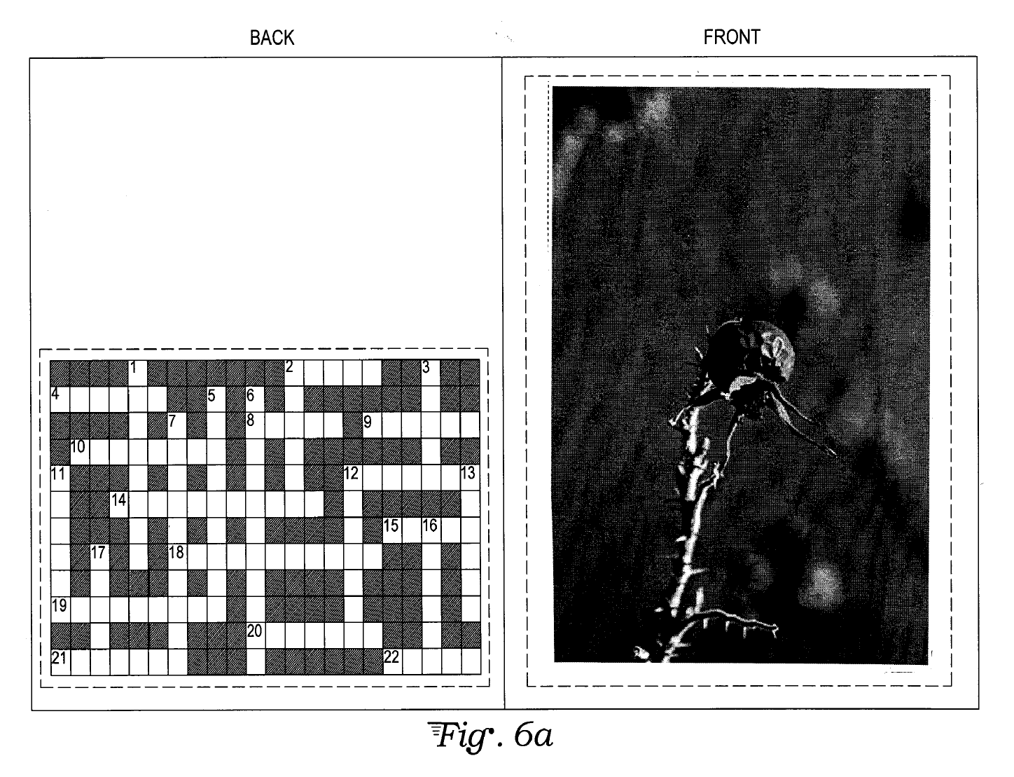

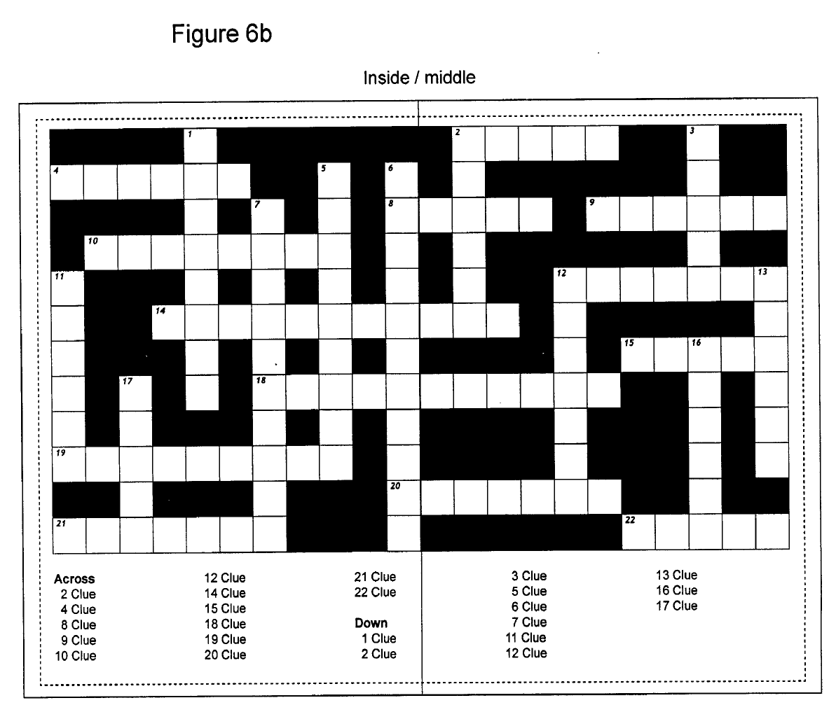

FIG. 6a shows the back and front of a double card postcard according to an embodiment of the invention depicting an autumn motif. FIG. 6b shows the inside/middle of the embodiment of FIG. 6a of a double card postcard bearing a crisscross crossword puzzle.

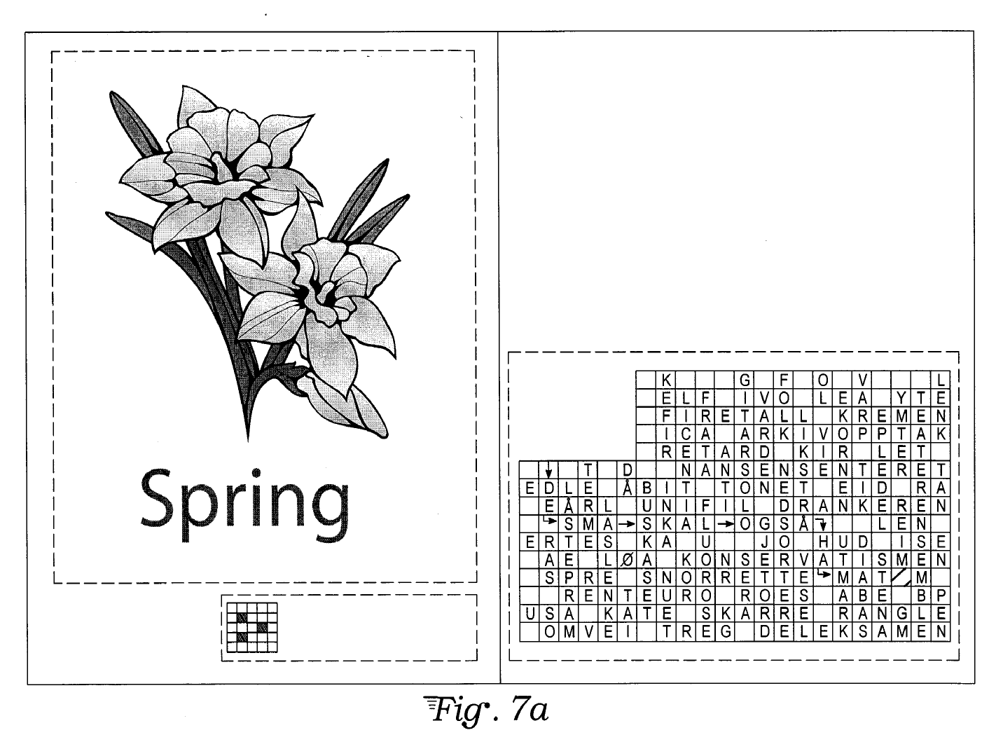

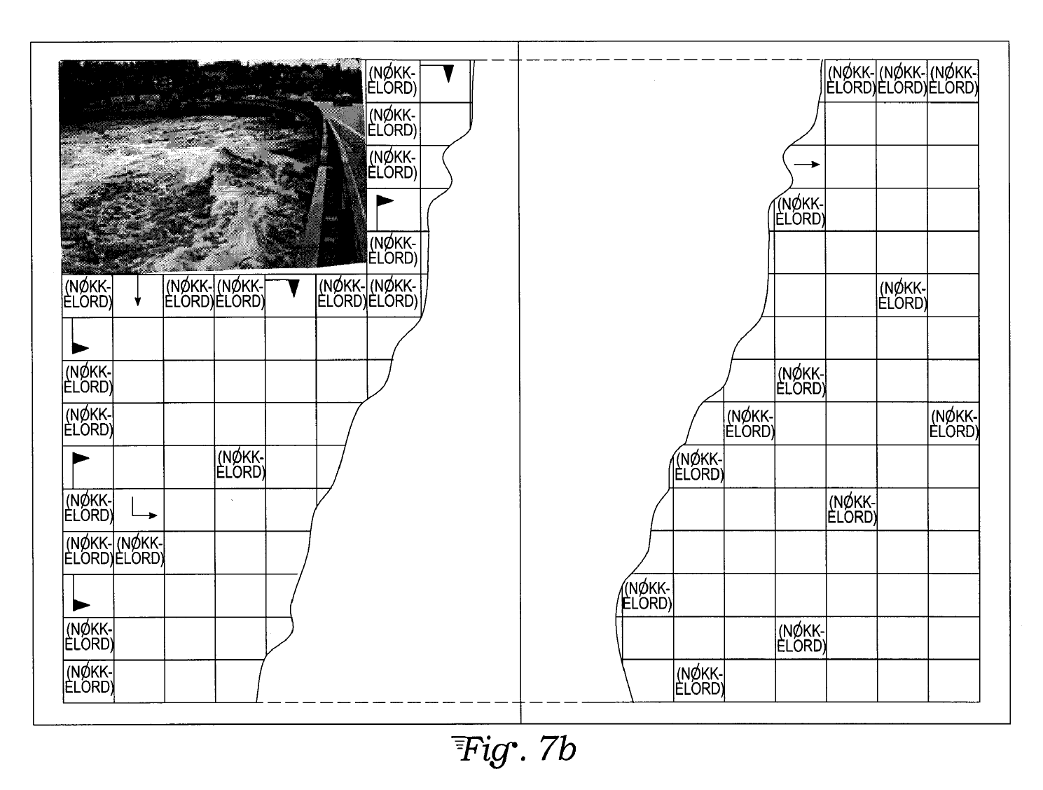

FIG. 7a shows the back and front of a double card postcard according to an embodiment of the invention depicting a spring motif. FIG. 7b shows the inside/middle of the embodiment of FIG. 7a of a double card postcard bearing a crossword puzzle.

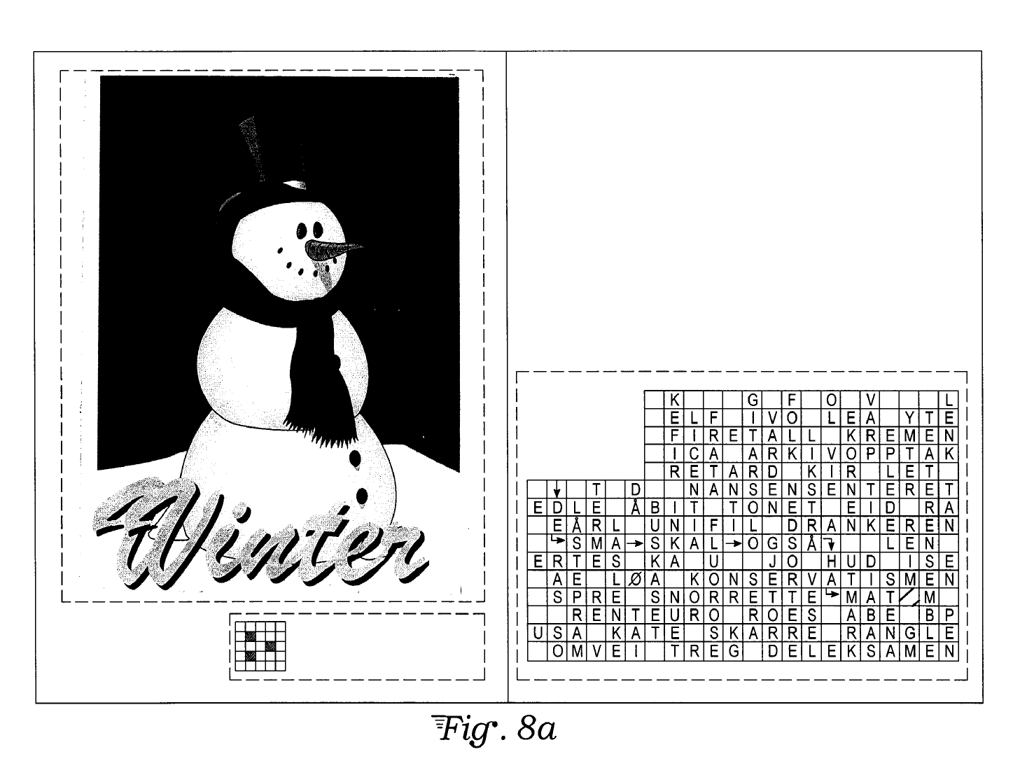

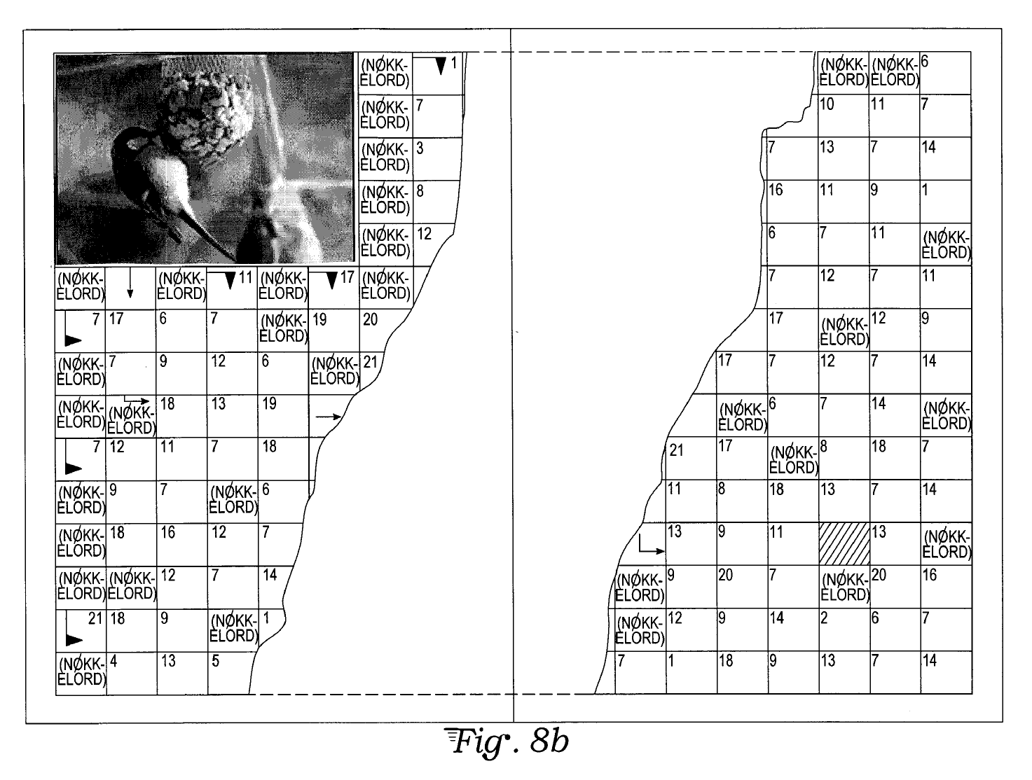

FIG. 8a shows the front and back of a double postcard according to an embodiment of the invention depicting a winter motif. FIG. 8b shows the inside/middle of the embodiment of FIG. 8a of a double card postcard bearing a crossword with a solution phrase relating to a corner picture in the crossword puzzle.

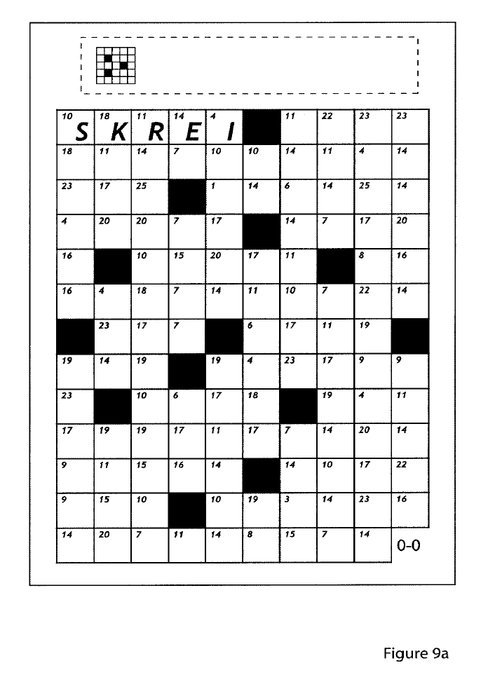

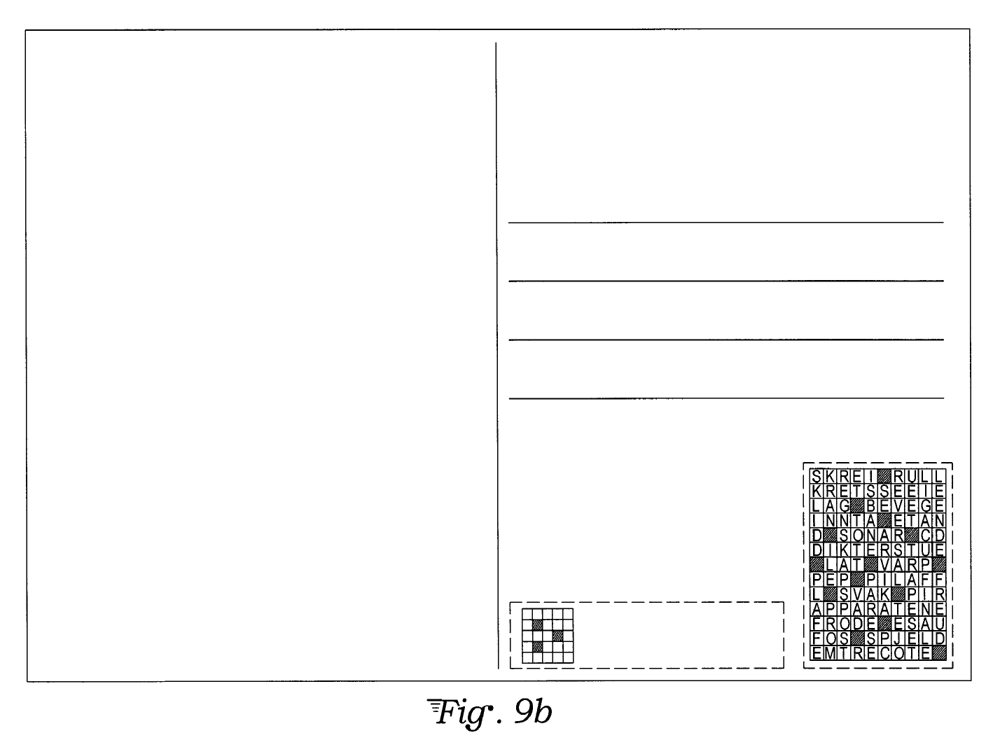

FIG. 9a shows the front of a single sheet postcard according to an embodiment of the invention bearing a code crossword. FIG. 9b shows the back of the embodiment of FIG. 9a also including the solution to the front side puzzle in a miniaturized version.

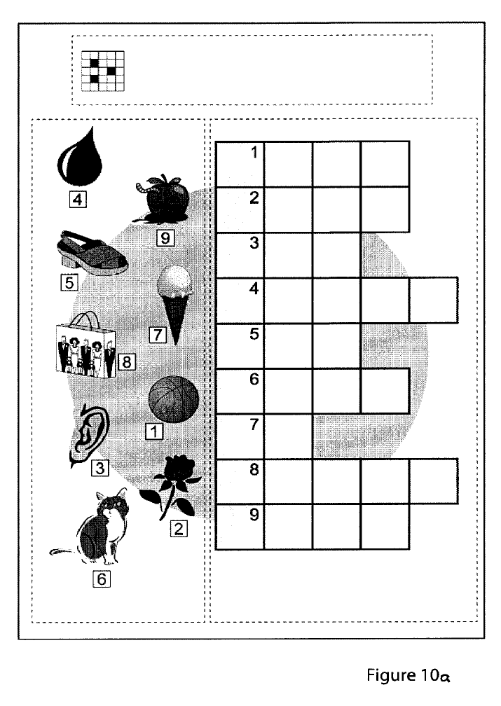

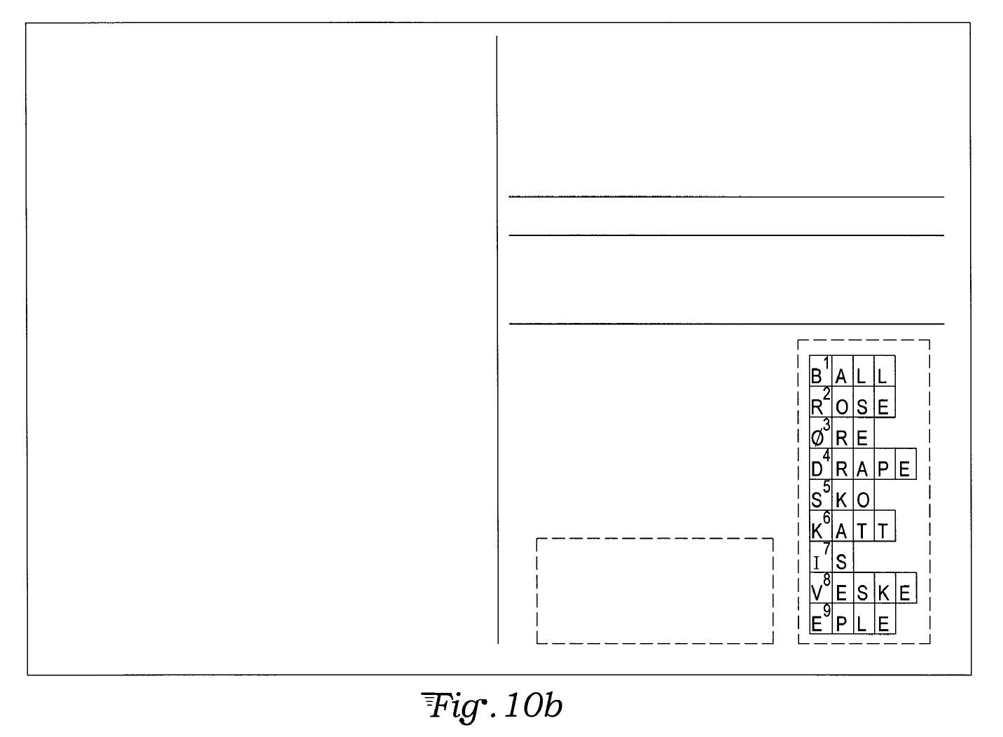

FIG. 10a shows the front of a single sheet postcard according to an embodiment of the invention bearing a crossword puzzle relating to pictures. FIG. 10b shows the backside of the embodiment of FIG. 10a bearing the solution to the crossword puzzle in a miniaturized version.

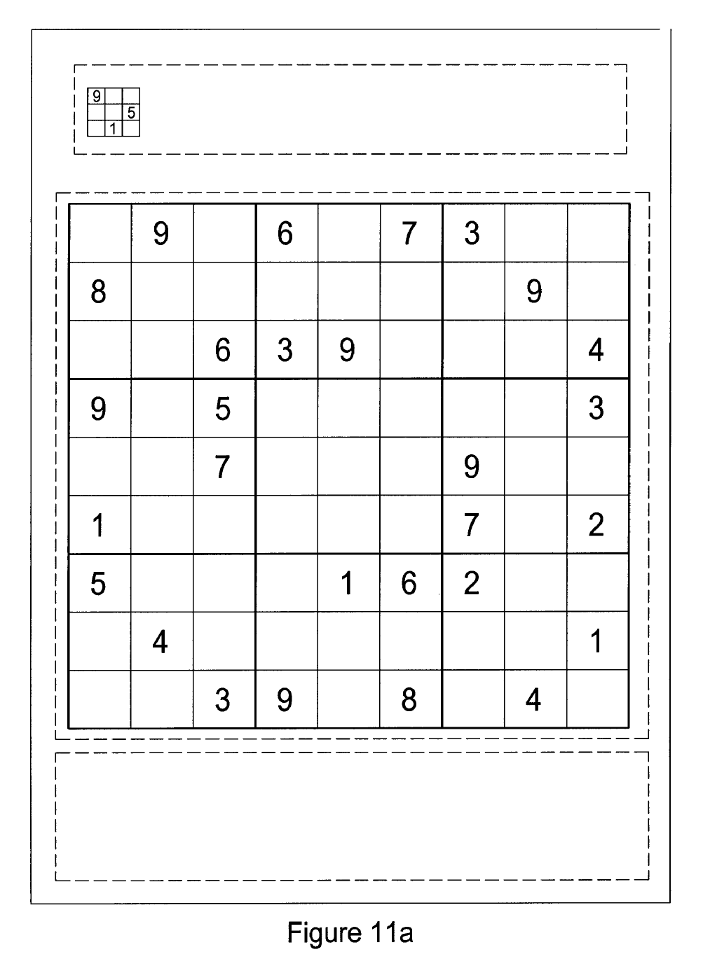

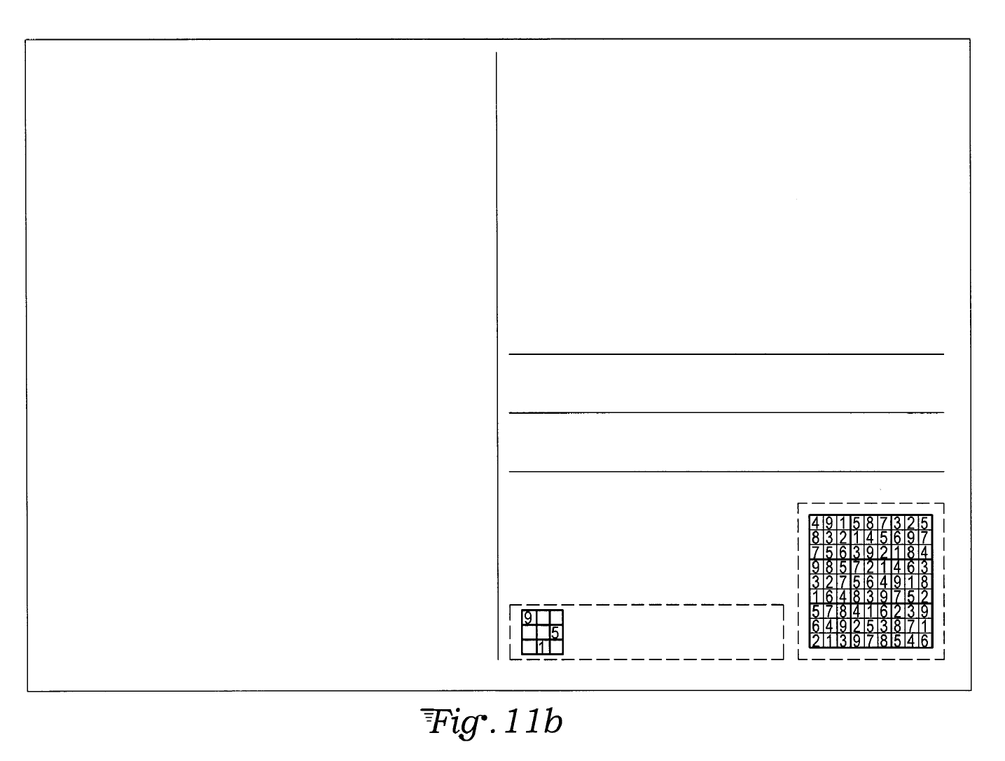

FIG. 11a shows the front of a single sheet postcard according to an embodiment of the invention bearing a Sudoku number puzzle. A Sudoku puzzle is a logic-based number placement puzzle. The objective is to fill an N×N (typically 9×9) grid so that each column, each row, and each of the sub-blocks (typically nine 3×3 regions) contains the digits from 1 to N (e.g., 9), only one time each (that is, exclusively). The puzzle setter provides a partially completed grid. Completed Sudoku puzzles are a type of Latin square, with an additional constraint on the contents of individual regions. FIG. 11b shows the FIG. 11a postcard on its backside bearing the solution to the Sudoku number puzzle in a miniaturized version.

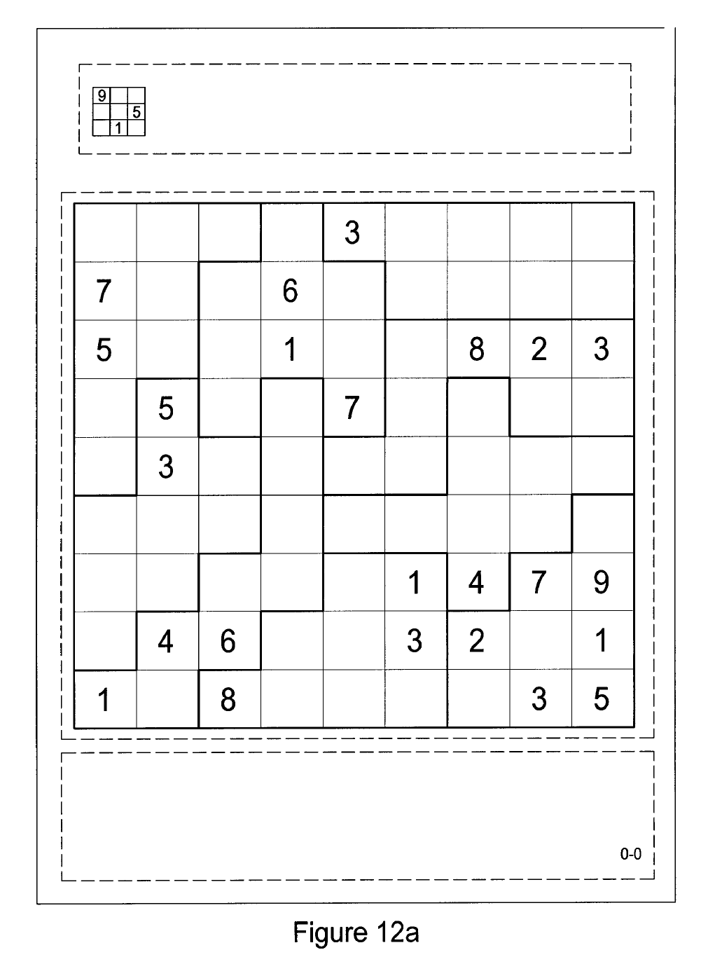

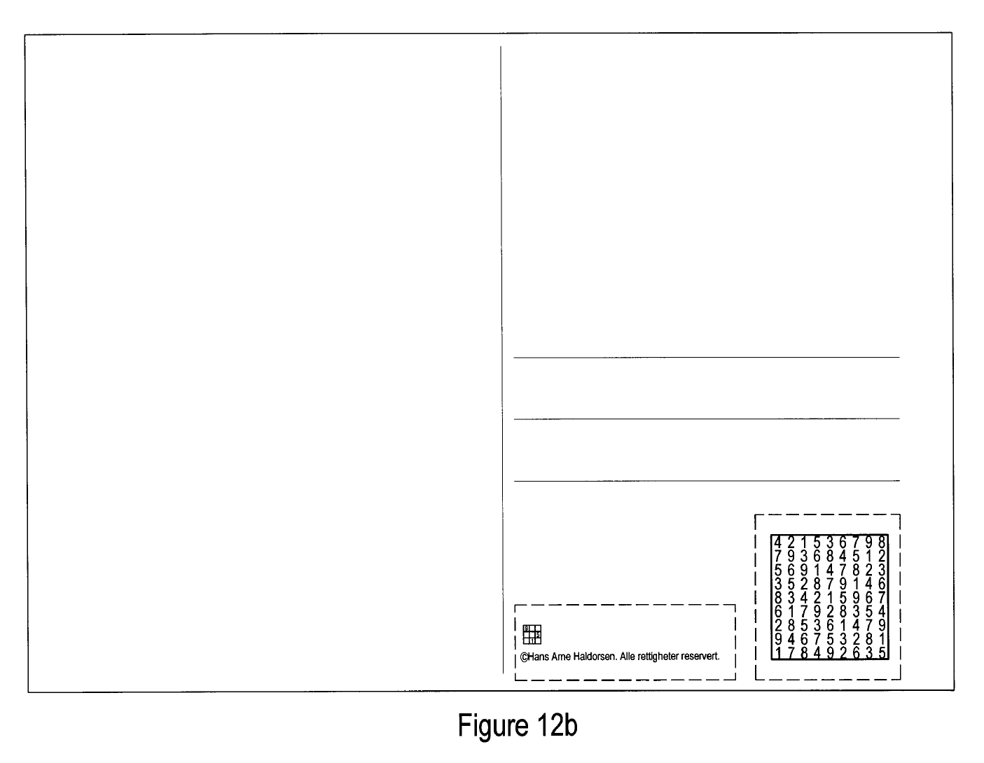

FIG. 12a shows the front of a single sheet postcard according to an embodiment of the invention bearing an alternative Sudoku number puzzle. FIG. 12b shows the FIG. 12a postcard on its backside bearing the solution to the Sudoku number puzzle in a miniaturized version.

In the foregoing specification, the invention has been described with reference to specific embodiments thereof. It will, however, be evident to a skilled artisan that various modifications and changes can be made thereto without departing from the broader spirit and scope of the invention as set forth in the appended claims. The specification and drawings are, accordingly, to be regarded in an illustrative rather than a restrictive sense.

I claim:

1. A puzzle postcard comprising:
a space for placing postage and a recipient's address;
a space adorned with a symbolic representation and/or for writing a message to the recipient of the postcard; and
at least one puzzle suited to be solved on a two-dimensional board.

2. The puzzle postcard according to claim 1, wherein the puzzle comprises:
a crossword puzzle involving finding words with common letters in a horizontal and vertical arrangement based on key words (synonyms) or phrases or pictures.

3. The puzzle postcard according to claim 1, wherein the puzzle comprises:
a Sudoku puzzle and/or a code puzzle relating numbers to words.

4. The puzzle postcard according to claim 1, wherein the postcard is shaped like:
a heart, a flower, a skull, a snowflake, or a square.

5. The puzzle postcard according to claim 1, wherein the card is of a single-sheet type, double-sheet type or multiple-sheet type with one or more foldings.

6. The puzzle postcard according to claim 1, further comprising:
pop-up structures and/or sound- and/or light-providing devices.

7. The puzzle postcard according to claim 1, further comprising:
a version of the puzzle filled in with the solution.

8. The puzzle postcard according to claim 7, wherein:
the version of the puzzle filled in with the solution is hidden under a removable cover.

9. The puzzle postcard according to claim 8, wherein: the removable cover comprises a peel-off label.

10. The puzzle postcard according to claim 8, wherein: the removable cover comprises opaque scratch-off material.
